(19) United States
(12) Patent Application Publication
(10) Pub. No.: US 2003/0041313 A1
(43) Pub. Date: Feb. 27, 2003

(54) User interface tool adapted to facilitate complete configuring of software objects

(76) Inventor: Mark Harmon, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/940,193

(22) Filed: Aug. 27, 2001

(51) Int. Cl. G06F 9/44

(52) U.S. Cl. 717/105; 717/121

(57) ABSTRACT

Disclosed are user interface tools adapted to guide a user through completion of a configuration or other process. Preferred embodiment user interface tools provide a software wizard which is adapted to provide the operator with information regarding the need to perform further configuration options, as well as, to facilitate the operator's completion of the configuration process. Preferably, a link is provided to allow communication between the user interface tool and an additional tool, such as a configuration tool used to provide configuration of software objects created by operation of the user interface tool.

### BACKGROUND

Computer software, such as application programs, system tools, and operating systems, is typically configurable to provide for at least a limited amount of customization or adaptation for particular uses. For example, software systems may allow for use with a variety of hardware components and, thus, allow an operator to configure the software for the particular hardware configuration of the user's host computer system. Similarly, software systems may provide flexible operation, features, or software component implementation and, thus, allow an operator to selectively implement such attributes or aspects of the software.

However, as software, and the host systems upon which software operates, becomes more and more advanced, the configurability and flexibility of such software systems has resulted in significant complexity with respect to an operator configuring or otherwise selectively implementing software attributes. Accordingly, user interface tools have been developed to provide an operator with basic guidance through the configuration process.

For example, software “wizards,” which themselves are a software component operable upon a host computer system, have been developed to provide an operator with an introductory amount of information to allow the operator to select software options at a general or high level. Software wizards typically provide a very high level of guidance with respect to selection of configuration options, such as providing a list of standard hardware components from which a desired hardware component might be selected during a software install process.

However, such high level guidance is often insufficient to address all the configurability or flexibility of the underlying software product. For example, although a software wizard may easily provide for selection between particular hardware components for use with the underlying software product, such software wizards generally cannot fully address the software product and/or hardware options which may be available.

Accordingly, an operator is typically left with a software product configuration which, although might be operable, is not fully configured and/or fully optimized for their particular deployment. Moreover, completion of use of the software wizard often leaves the operator with the impression that all that is necessary and/or recommended in configuring the software product has been accomplished.

A need therefore exists in the art for systems and methods which provide user interface tools which not only provide high level guidance with respect to configuration options, but which further inform the operator that further configuration is available and provides simplified access to more detailed configuration options.

### SUMMARY OF THE INVENTION

One embodiment of the invention provides a user interface tool comprising a software object creation process which provides guidance to a user with respect to creation of a software object. The software object creation process of this embodiment further comprises an information communication link to a software object editor. The information communication link provided by the user interface tool preferably provides information with respect to a software object created by the software object creation process to facilitate operation of the software object editor.

Another embodiment of the invention provides a method for configuring a software object providing guidance to a user with respect to selection of attributes of a software object. The method of this embodiment additionally provides information to the user with respect to configuring selected attributes of the software object. The method preferably provides information with respect to the software object to a software object editor to facilitate configuring attributes of the software object.

Still another embodiment of the invention provides a computer program product for use in creating a data collector and providing configuration of said data collector. The computer program product preferably comprises a computer readable media having computer readable code stored thereon. The computer readable code preferably includes a data collector creation process providing guidance to a user with respect to creation of a software object. The computer readable code also preferably includes a data collector configuration option process operable after substantial completion of said data collector creation process. The data collector configuration option process preferably provides information with respect to configuration of the software object created by the data collector creation process. The data collector configuration option process preferably includes a user selectable option to establish a communication link with and launch an external editor process to provide information with respect to said data collector created by the data collector creation process to facilitate configuration of the data collector. The data collector configuration option process also preferably includes a user selectable option to repeat operation of the data collector creation process and the data collector configuration option process for creating and configuring a plurality of data collectors.

### BRIEF DESCRIPTION OF THE DRAWING

FIGS. 1A-1G show user interface screens representing the operational flow of a prior art software wizard for creating data collectors;

FIG. 2 shows a high level block diagram of a user interface tool adapted according to a preferred embodiment of the present invention;

FIGS. 3A-3G show user interface screens representing the operational flow of a software wizard for creating data collectors adapted according to a preferred embodiment of the present invention;

FIG. 3H shows a user interface screen of a configuration editor in communication with the software wizard of FIGS. 3A-3G according to a preferred embodiment of the present invention; and

FIG. 4 depicts a block diagram of a computer system which is adapted to use the present invention.

### DETAILED DESCRIPTION

Many software systems in use today, such as application programs, system tools, and operating systems, allow for user configuration of attributes thereof. However, as the features and functions of such software becomes more robust, the configurability and flexibility results in significant complexity for an operator to manage configuring or otherwise selectively implementing software attributes. Accordingly, user interface tools, such as software “wizards,” have been developed to provide an operator with basic guidance through the configuration process. Typically, software wizards have been developed to provide an operator with an introductory amount of information to allow the operator to select software options at a general or high level. Such software wizards are typically operable upon a general purpose processor-based system such as a personal computer (PC), such as those employing the PENTIUM microprocessor platform available from Intel Corporation. Software wizards are generally operable with a graphical user interface such as WINDOWS available from Microsoft Corporation.

One such software wizard has been provided as a user interface tool with respect to the SMART INTERNET USAGE (SIU) software product available from the Hewlett Packard Company, Palo Alto, Calif., to guide an operator through creating SIU data collectors. The SIU software product may be described as middleware, as it provides one of the components of a complete solution that a particular customer may be deploying. The SIU software product provides for measuring the usage of a particular configuration of network components. The nature of an SIU deployment is that the SIU software product itself is very highly configurable and can do almost an infinite number of tasks, depending on how it is configured to operate. In general, the SIU software product provides a data flow model of operation for network utilization information.

Data collectors are a fundamental software component in the SIU software product. Typically, an SIU deployment will include a number of these data collectors which collect information from a network, process the data, and then provide output to any number of other applications, such as a database for storage, billing software, or reporting software. For example, data collectors may be provided for monitoring network usage, the amount of data that goes across a network, or any number of different parameters related to how subscribers are using a network and/or its components.

Typically, an SIU deployment will include a plurality of data collectors, such as a data collector for every network device for which usage data is to be monitored and/or measured. Data collectors may also be used to collect data from other data collectors. Accordingly, an SIU deployment may result in a hierarchical “tree” of data collectors providing stages of data collection, processing, aggregation, and storage.

Each stage of data collectors in an SIU deployment may process or aggregate the network device data or data collector data of a previous stage. For example, the first stages are generally employed in collecting raw usage data, like SNMP, network traffic information, Cisco System, Inc.'s NETFLOW Internet Protocol (IP) information, and/or the like.

The data gathered by the first stage data collectors is converted into a standard format or protocol of data flowing through the data collectors, referred to herein as Normalized Metered Events (NME). Thereafter, aggregation of the data is provided by each first stage data collector to attempt to combine information which the data collector has gathered together to reduce the data to a manageable and useful compilation of information. For example, if data is collected in real time directly from a network, a considerable volume of data may be collected at a very fast rate. Accordingly, it may be desirable to summarize the information, such as to describe the information in a more succinct way. This summarized information is stored by the first stage data collectors for collection and aggregation by subsequent data collector stages.

The next stage of data collectors may include data collectors which combine data from a number of various first stage collectors. For example, where the first stage data collectors are reading data from several different nodes on the network, a second stage data collector may combine a portion of that data as aggregated by multiple first stage data collectors, such as to provide composite information instead of keeping the information tallied separately. As the information is passed through the various stages of data collectors of the SIU deployment, the data is aggregated down into the essential usage information the customer is interested in knowing about.

Accordingly, it should be appreciated that, for every network device that a user is interested in obtaining information from, an operator must create a corresponding data collector. Moreover, the operator must create data collectors for each stage of further data collection or aggregation. Accordingly, an SIU deployment may involve the creation of a very large number of data collectors, each of which must be configured according to their intended use.

An operator, such as a network administrator, is therefore required to create and configure the desired data collectors during a process of building the SIU deployment. For example, an operator may select a data collector type from a plurality of data collector types for a particular data collector to be utilized in the deployment. Thereafter, the operator may select a particular data collector encapsulator to provide for the data collector reading data from some source in the network. Similarly, the operator may select a data collector aggregator to process the data that is read by the selected encapsulator. The operator may also select a data collector data store to provide storage of data aggregated by the data collector.

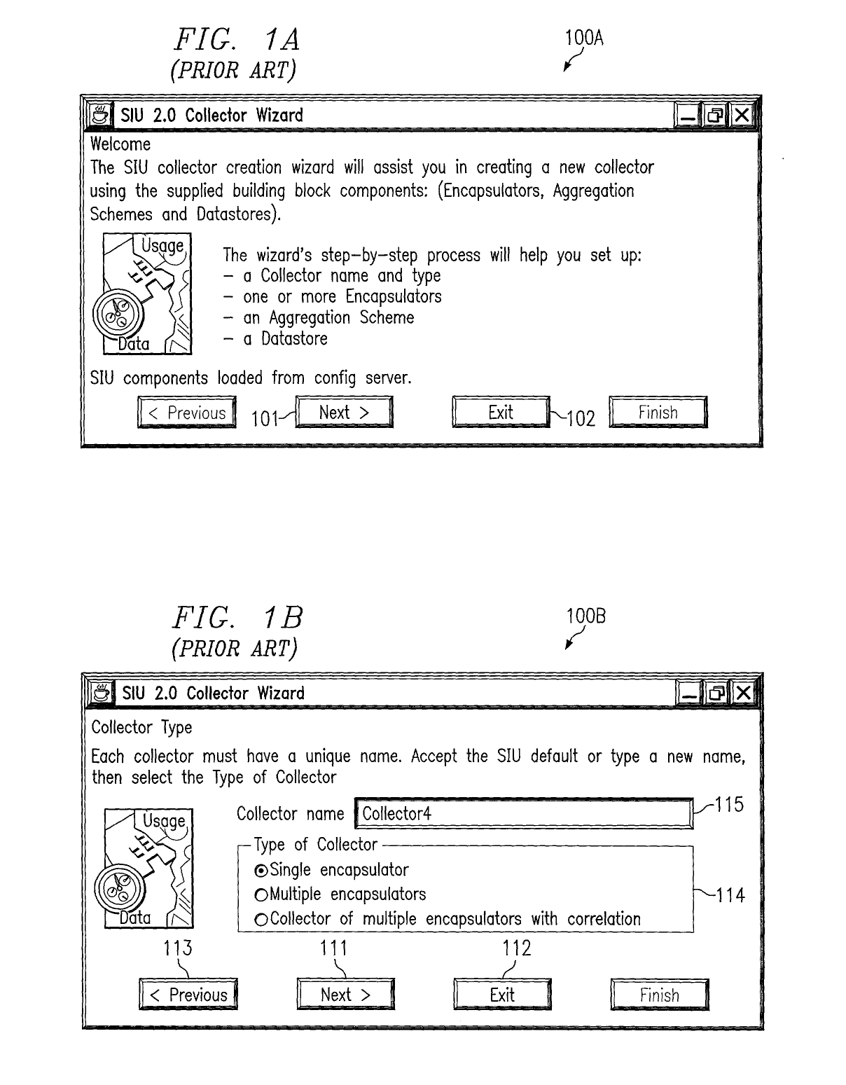

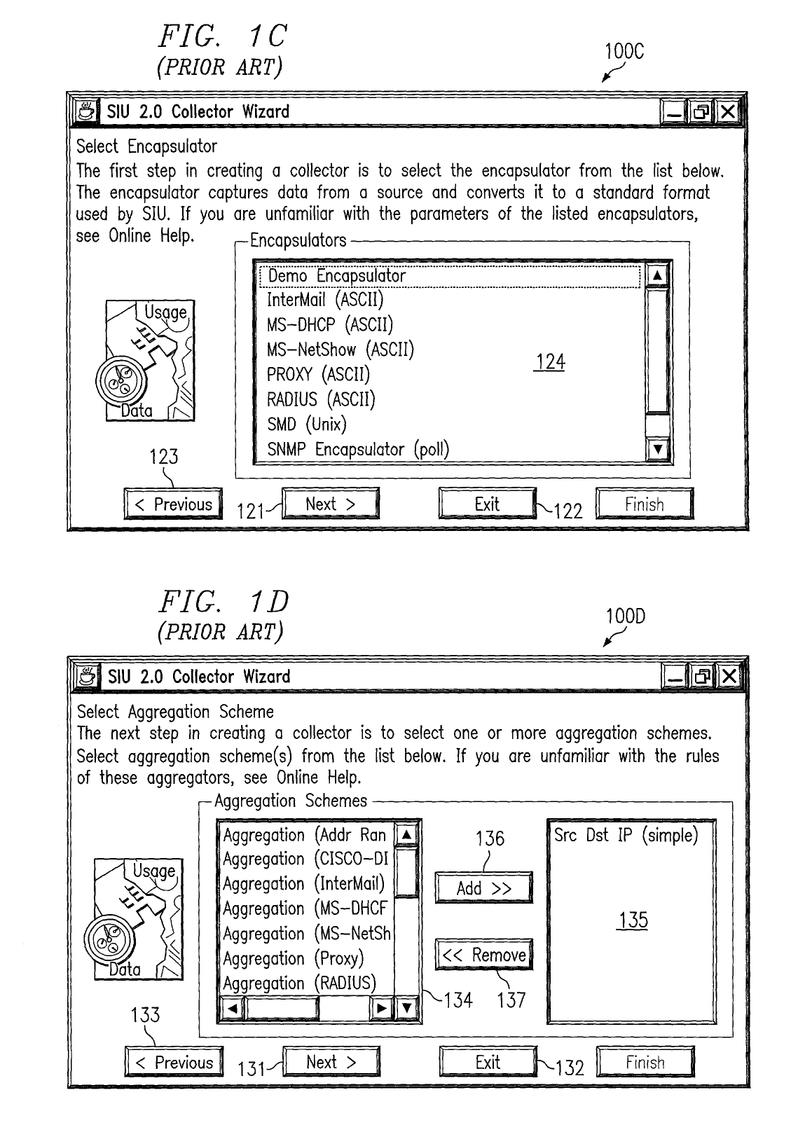

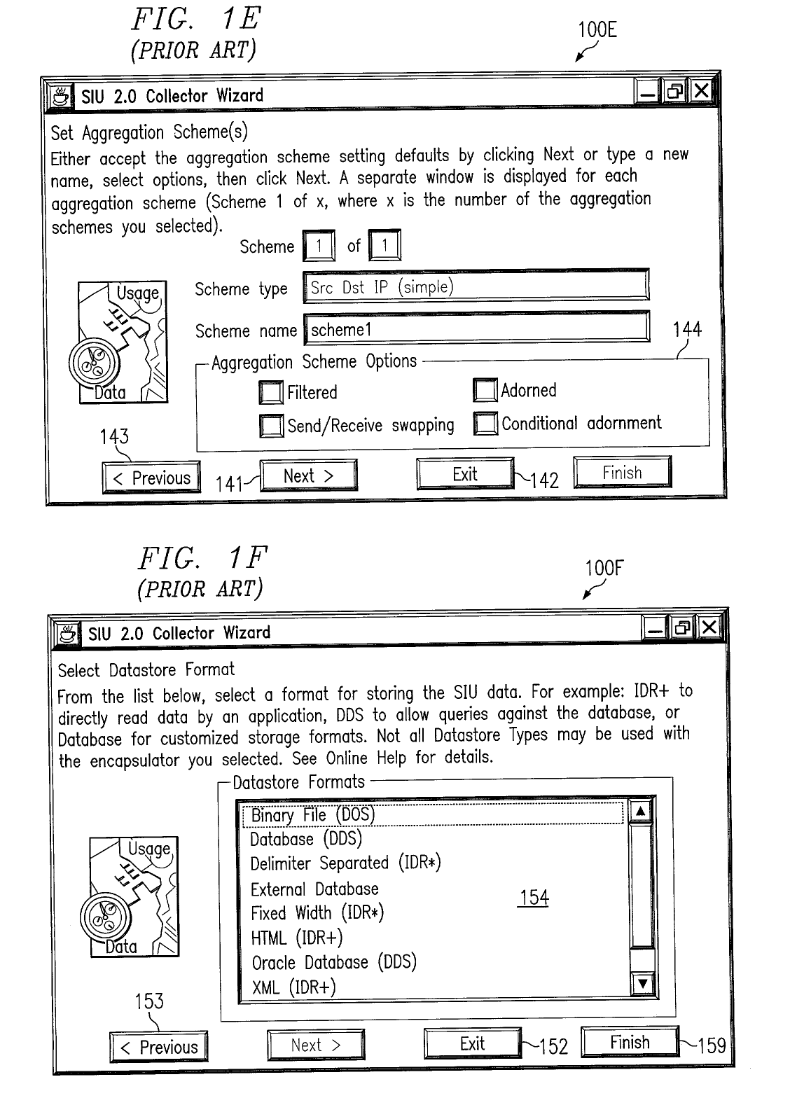

A conventional software wizard may be implemented to provide high level guidance with respect to an operator's creation of such data collectors. Directing attention to FIGS. 1A-1G, a prior art implementation of a software wizard to guide creation of data collectors in the configuration steps described above is shown. The collector wizard of FIGS. 1A-1G is a step by step user interface tool which walks the operator through the process of creating each of the above described three components of the data collector.

Specifically, the data collector wizard of FIGS. 1A-1G begins with welcome screen 100A providing basic information as to the function of the data collector wizard. Welcome screen 100A allows an operator to proceed with creation of a data collector using the data collector wizard (button 101) or exit the data collector wizard (button 102).

The first entry step of the data collector wizard is to allow an operator to select the basic type of data collector being created (box 114) and to provide a unique name for the data collector being created (box 115) at collector type screen 100B. Also provided within collector type screen 100B are wizard navigation buttons 111-113 allowing an operator to proceed to a next step (button 111), to exit the data collector wizard (button 112), or to return to a previous step (button 113).

A subsequent entry step of the data collector wizard is to allow an operator to specify the basic type of device data is to be collected from by selecting an encapsulator to be used by the data collector (box 124) at select encapsulator screen 100C. Also provided within select encapsulator screen 100C are wizard navigation buttons 121-123 allowing an operator to proceed to a next step (button 121), to exit the data collector wizard (button 122), or to return to a previous step (button 123).

Another subsequent entry step of the data collector wizard is to allow an operator to select the aggregation scheme or schemes to be used by the data collector (boxes 134 and 135) using add button 136 and remove button 137 at select aggregation scheme screen 100D. Also provided within select aggregation scheme screen 100D are wizard navigation buttons 131-133 allowing an operator to proceed to a next step (button 131), to exit the data collector wizard (button 132), or to return to a previous step (button 133).

At set aggregation schemes screen 100E, the data collector wizard allows an operator, at a high level, to set aggregation options for the aggregation schemes (box 144) selected in select aggregation scheme screen 100D. It should be appreciated that set aggregation schemes screen 100E may be repeated for each aggregation scheme selected in select aggregation scheme screen 100D. Also provided within set aggregation schemes screen 100E are wizard navigation buttons 141-143 allowing an operator to proceed to a next step (button 141), to exit the data collector wizard (button 142), or to return to a previous step (button 143).

A final entry step of the data collector wizard of FIGS. 1A-1G allows an operator to select a data storage format for data collected and aggregated by the data collector (box 154) at select datastore format screen 100F. Also provided within select datastore format screen 100F are wizard navigation buttons 152, 153, and 159 allowing an operator to exit the data collector wizard (button 152), to return to a previous step (button 153), or acknowledge completion of the data collector creation (button 159). It should be appreciated that a wizard navigation for a next entry step is not provided in select datastore format screen 100F. This is because finish button 159 has been provided in place thereof in order to ensure that the operator is satisfied with the configuration options selected before proceeding in the data collector wizard as the subsequent finish screen does not provide a return to previous step button.

When an operator engages finish button 159, collector finished screen 100G is displayed. Collector finished screen 100G allows an operator to exit the data collector wizard (button 162). The data collector wizard also allows an operator to exit the data collector wizard and launch a graphical user interface (button 166) to provide a graphical view of a deployment of data collectors. Additionally, the data collector wizard allows an operator to exit the data collection wizard and start operation of the created data collector itself (button 167) or view log files (box 168) with respect to the operation of data collectors for which operation has been started.

As can be readily appreciated from the above described multiple stage data collector deployment, there are likely to be a relatively large number of data collectors to be created. Accordingly, the data collection wizard illustrated in FIGS. 1A-1G may be relaunched for repeating the steps thereof for each such data collector to be created.

Moreover, it should also be appreciated from the above described multiple stage data collector deployment that SIU data collectors are highly configurable. For example, although many network components may provide data in a format of a particular encapsulator of a data collector, the protocols in which such data is provided may vary significantly. Accordingly, parsers may be configured for particular encapsulators in order to parse incoming raw data and convert it to NMEs. Additionally, an NME format may be configured by selecting particular fields to be used based upon the data source and the data to be processed and saved.

Particular physical or logical addresses from which such data is to be obtained and/or provided to may be provided to the data collector. Accordingly, in order to provide a properly operational data collector, the data collectors created by the data collector wizard of FIGS. 1A-1G must be further configured after completion of the data collector wizard.

In order for a user to fully configure the created data collectors, a separate configuration program, such as a data collector editor or software object editor, must be launched and the proper data collector loaded in the editor for configuration. This typically requires the user to exit the data collection wizard, search through a data storage hierarchy to locate the storage location of the created data collectors, search through a plurality of created data collectors for the particular data collector the user wishes to edit, locate and execute the appropriate editor program, and load the particular data collector for editing.

Accordingly, it should be appreciated that the data collector wizard provides guidance with respect to approximately the first 10% of what is needed to actually create a complete and fully configured data collector. The remaining 90% of the data collector configuration is left unaddressed by the operation of the data collector wizard of FIGS. 1A-1G.

Specifically, the data collector wizard of FIGS. 1A-1G walks the operator through the general creation/configuration steps and stops, like many conventional software wizards, providing only the introductory amount of information to get the user started with respect to configuration aspects. As such, the software wizard implementation of FIGS. 1A-1G provides multiple high level configuration steps, but does not provide the ability to customize the choices made by the operator to actually result in a data collector which performs as necessary for a successful SIU deployment. Moreover, the software wizard, in conventional fashion, does not even provide the operator with information regarding the need to perform further configuration operations.

The present invention provides user interface tools, such as a software object creation process, adapted to guide a user through completion of a configuration or other process. Accordingly, a software wizard operable according to a preferred embodiment of the present invention is specifically adapted both to provide the operator with information regarding the need to perform further configuration options as well as to facilitate the operator's completion of the configuration process. For example, a software object creation process may provide information with respect to the need to configure a created software object and provide an information communication link with a software object configuration option process to facilitate such configuration, according to a preferred embodiment of the present invention.

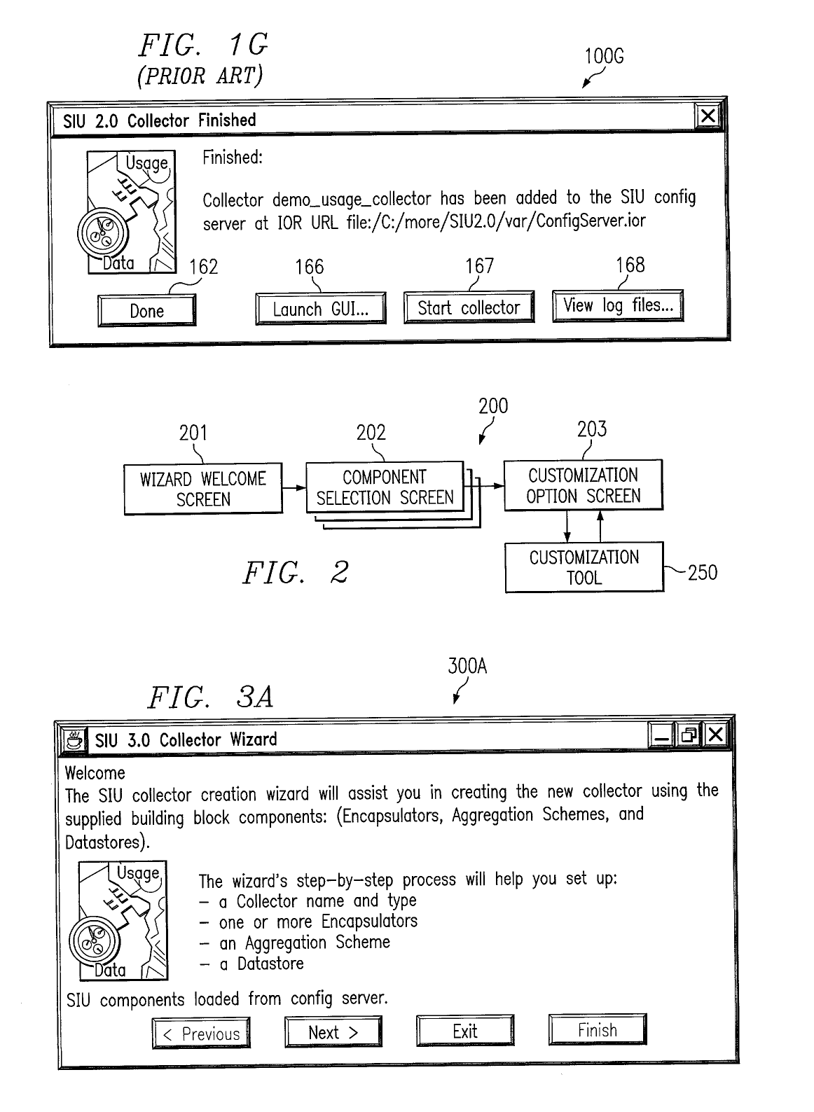

Directing attention to FIG. 2, a high level diagram of a user interface tool adapted according to a preferred embodiment of the present invention is shown. Specifically, improved data collector wizard 200 is shown to include welcome screen 201, component selection screens 202, and customization option screen 203. Improved data collector wizard 200 is further shown to be in communication with customization tool 250.

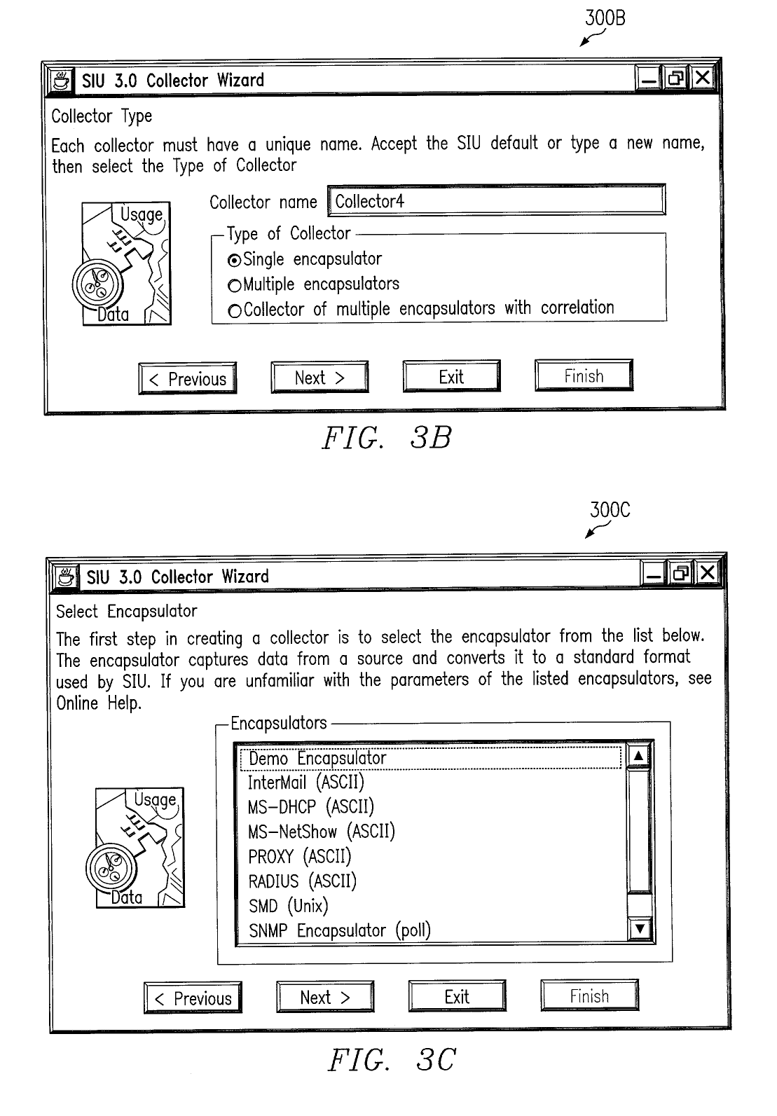

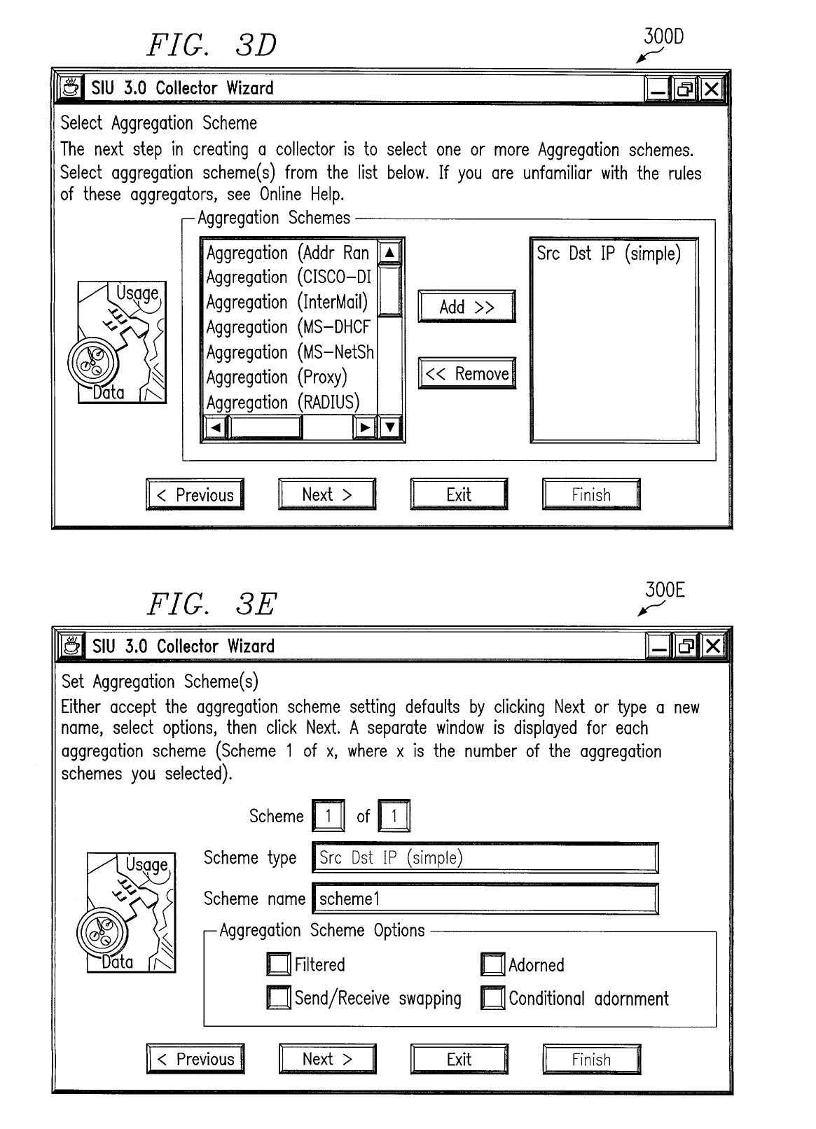

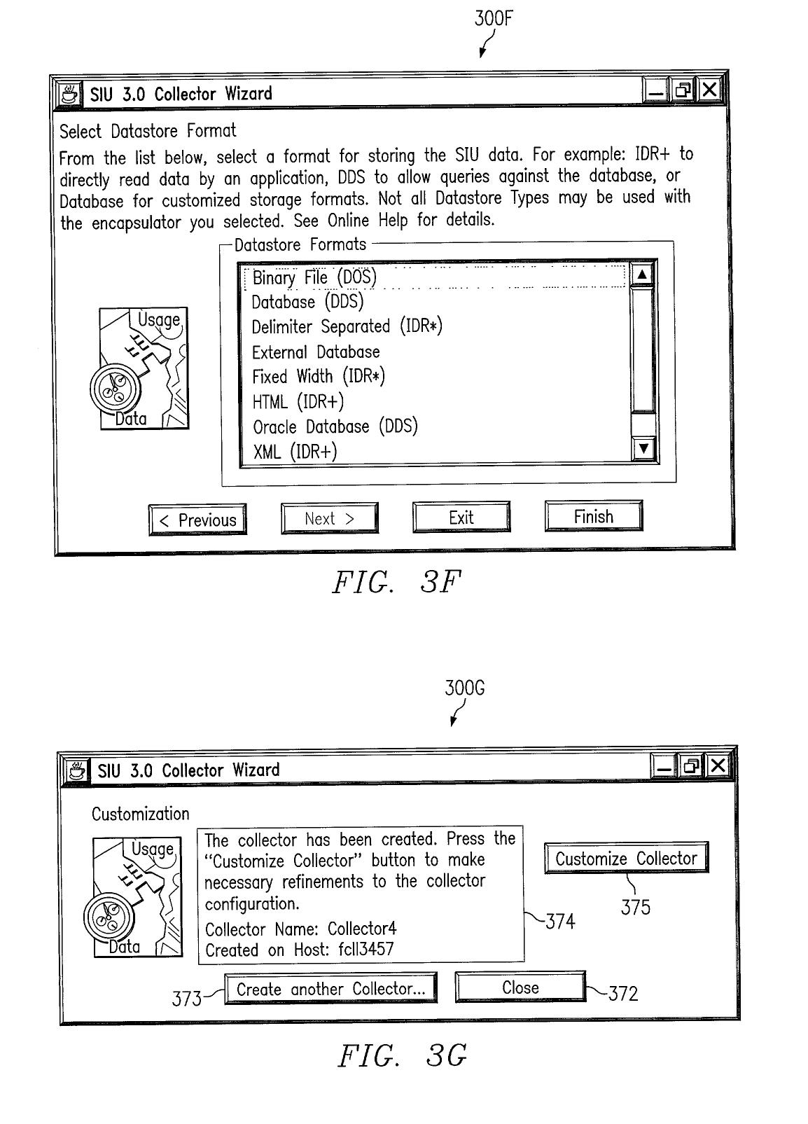

As will be better appreciated from the description of the embodiment illustrated in FIGS. 3A-3H, improved data collector wizard 200 may provide high level configuration guidance to a user in a substantially conventional manner, in addition to providing the operator with information regarding the need to perform further configuration options and facilitating the operator's completion of the configuration process. For example, wizard welcome screen 201 may provide brief instructions to the operator with respect to what the wizard is going to do. Thereafter, improved data collector wizard 200 may provide a variable number of entry screens, such as may be dependent upon the type of data collector the operator wishes to create, to allow high level selection of data collector components, as shown by component selection screens 202.

However, in contrast to conventional software wizard implementations, improved data collector wizard 200 does not provide a conventional finish screen following the entry screens, but instead provides customization option screen 203. Customization option screen 203 of the preferred embodiment provides the operator with information regarding the need to perform further configuration options. Additionally, customization option screen 203 of the preferred embodiment provides communication between improved data collector wizard 200 and customization tool 250, external thereto, in order to facilitate the operator's completion of the configuration process. Accordingly, improved data collector wizard 200 provides a single continuous process to the user which performs high level creation and configuration of data collectors, informs the user that there is more configuration necessary with respect to the created data collectors, and gives the user access to the appropriate configuration tool.

A preferred embodiment of improved data collector 200 is shown in further detail in FIGS. 3A-3H. Similar to the data collector wizard of FIGS. 1A-1G, improved data collector 200 of FIGS. 3A-3H begins with welcome screen 300A providing basic information as to the function of the data collector wizard. The first entry step of improved data collector wizard 200 as illustrated is to allow an operator to select the basic type of data collector being created and to provide a unique name for the data collector being created at collector type screen 300B. A subsequent entry step of the illustrated embodiment of improved data collector wizard 200 allows an operator to specify the basic type of device data is to be collected from by selecting an encapsulator to be used by the data collector at select encapsulator screen 300C. Another subsequent entry step of the illustrated embodiment of improved data collector wizard 200 allows an operator to select the aggregation scheme or schemes to be used by the data collector at select aggregation scheme screen 300D. At set aggregation schemes screen 300E, improved data collector wizard 200 preferably allows an operator to set aggregation options for the selected aggregation schemes, with set aggregation schemes screen 300E preferably being repeated for each aggregation scheme selected in select aggregation scheme screen 300D. A subsequent entry step of the illustrated embodiment of improved data collector wizard 200 allows an operator to select a data storage format for data collected and aggregated by the data collector at select datastore format screen 300F.

It should be appreciated that, like the data collection wizard of FIGS. 1A-1G, the above described screens of the illustrated embodiment of improved data collector 200 may include various buttons to allow an operator to navigate through the screens. Specifically, the above described screens may include buttons allowing an operator to proceed to a next step, to exit the data collector wizard, to return to a previous step, or acknowledge completion of the data collector creation, depending upon the disposition of the associated screen in the hierarchy of screens.

However, in contrast to the data collection wizard of FIGS. 1A-1G, the preferred embodiment of improved data collector wizard 200 does not proceed to a conventional finish screen when an operator acknowledges completion of creating a desired data collector. Instead, improved data collector wizard 200 preferably proceeds to a screen providing information with respect to the operator's need to perform further configuration and providing a means by which the operator may perform further configuration steps. Accordingly, the illustrated embodiment of improved data collector wizard 200 displays customization option screen 300G in response to an operator's acknowledgment of completion of creating a desired data collector.

The preferred embodiment of customization option screen 300G provides dialogue informing an operator that additional configuration should be performed (box 374). Customization option screen 300G may provide additional information, such as uniquely identifying the data collector created, identifying a storage location of the created data collector, or any other information which may be helpful to an operator.

In addition to customization option screen 300G allowing an operator to close and exit improved data collection wizard 200 (button 372), customization option screen 300G provides an operator with options to aid the operator in fully completing an SIU deployment. Specifically, customization option screen 300G allows an operator to repeat the steps of the data collection wizard to create additional data collectors (button 373) and allows an operator to complete configuration of a data collector by communicating with the appropriate tool (button 375).

In operation according to a preferred embodiment, selection of customize collector (button 375) by an operator leaves customization option screen 300G in tact and launches another dialog, e.g., a data collector editor 350 of FIG. 3H, to give the operator the ability to fully customize the collector as part of the creation process. Moreover, in order to facilitate the operator's configuration of the data collector, information is preferably passed between improved data collector wizard 200 and this subsequent dialog. For example, improved data collector wizard 200 may pass information uniquely identifying the last created data collector and/or the storage location for the data collector to a data collector editor in order to place the operator in a position to simply complete the configuration of the data collector. Not only may the link between improved data collection wizard 200 launch the editor dialog and take the operator into the editor for the specific data collector that has been created, but it may also take the operator to the specific fields within that editor that relate to a particular aspect that is to be configured by providing an information communication link therebetween. Accordingly, the operator is relieved of the burden of trying to identify and locate the data collector that was created and launching an editor based on that information.

Upon launching of data collector editor 350 by improved data collector wizard 200, the operator is preferably free to fully configure all attributes of the created data collector to thereby provide a fully operational data collector. Accordingly, the operator is provided a seamless series of steps from which a data collector may be created and fully configured.

Preferably, when the operator has completed configuring the data collector, data collector editor 350 is closed, such as by selection of an “OK” button therein, and the configuration changes to the data collector are applied. Thereafter, according to the preferred embodiment, the operator is returned to customization option screen 300G. Accordingly, the operator may then elect to create another data collector (button 373), close and exit the data collector wizard (button 372), or even further edit the data collector (button 375).

Operation according to the preferred embodiment of the present invention continues to allow manual configuration any data collector created by the data collector wizard. Accordingly, a user may elect not to complete the configuration of a data collector created by improved data collector wizard 200, such as by selecting the “create another collector” button without selecting the “customize collector” button after creating a data collector. After exiting the data collector wizard, the user may then elect to launch the data collector editor and provide any necessary data collector configuration steps.

It should be appreciated that the present invention provides a user interface tool adapted to guide a user through completion of a configuration or other process by providing information with respect to steps required to complete the configuration or other process. Moreover, a user interface tool adapted according to a preferred embodiment of the present invention guides a user through completion of a configuration or other process by providing access to, and information communication with, external processes for utilization. Preferably, this access and information communication not only helps guide the user to proper completion of the task, but also operates to streamline the process, such as by saving the user steps in identifying appropriate information, identifying an appropriate external process, exiting a user interface tool, and/or properly launching the appropriate external process.

An additional advantage of a preferred embodiment of the present invention is that the use of an external process, such as for further configuration, is provided for in such a way as to accommodate repeated use of the user interface tool without exiting therefrom. Accordingly, a user may launch a user interface tool adapted according to the present invention a single time and operate the user interface tool to perform a desired task, such as create a particular software object. The user may further use the user interface tool to execute an external process, such as to edit a created software object. The user may further use the user interface tool to repeat these steps indefinitely, such as to create a number of edited software objects. In a situation where repeated operation of the user interface tool is desired, such as in creating the relatively large number of data collectors associated with an SIU deployment as described above, this feature of the present invention results in a significant savings of time.

It should be appreciated that alternative embodiments of the present invention may provide information with respect to the need to perform additional steps and/or provide information communication between the user interface tool and an external process at points other than that illustrated above with respect to a preferred embodiment. For example, there is no requirement that the present invention provide for completed creation of a particular software object before providing a user information with respect to performing additional configuration and/or providing a link to a configuration editor.

Accordingly, an embodiment of the present invention may provide information with respect to completing configuration of various attributes of a software object where a corresponding aspect is initially selected. For example, the present invention may provide information with respect to configuring an encapsulator in association with a select encapsulator screen, such as providing information and an external process link button on select encapsulator screen 300C or providing a screen with information and an external process link button on a screen following select encapsulator screen 300C.

However, particular embodiments of the present invention provide at least the link to the external process after completion of the initial user interface tool steps in order to more easily accommodate the use of navigation control provided for within the user interface tool. Allowing such customization at various such points may require a decision to be made when a user elects to return to a previous point in the process as to whether or not to undo the latter changes that have been made in order to back up to a prior point and then proceed forward again. Placing customization options at many points in the process may make that process difficult, both from an implementation standpoint and from a use model standpoint.

It should be appreciated that the present invention may be implemented in software, the elements of which being essentially the code segments to perform the necessary tasks. The program or code segments can be stored as processor readable code in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

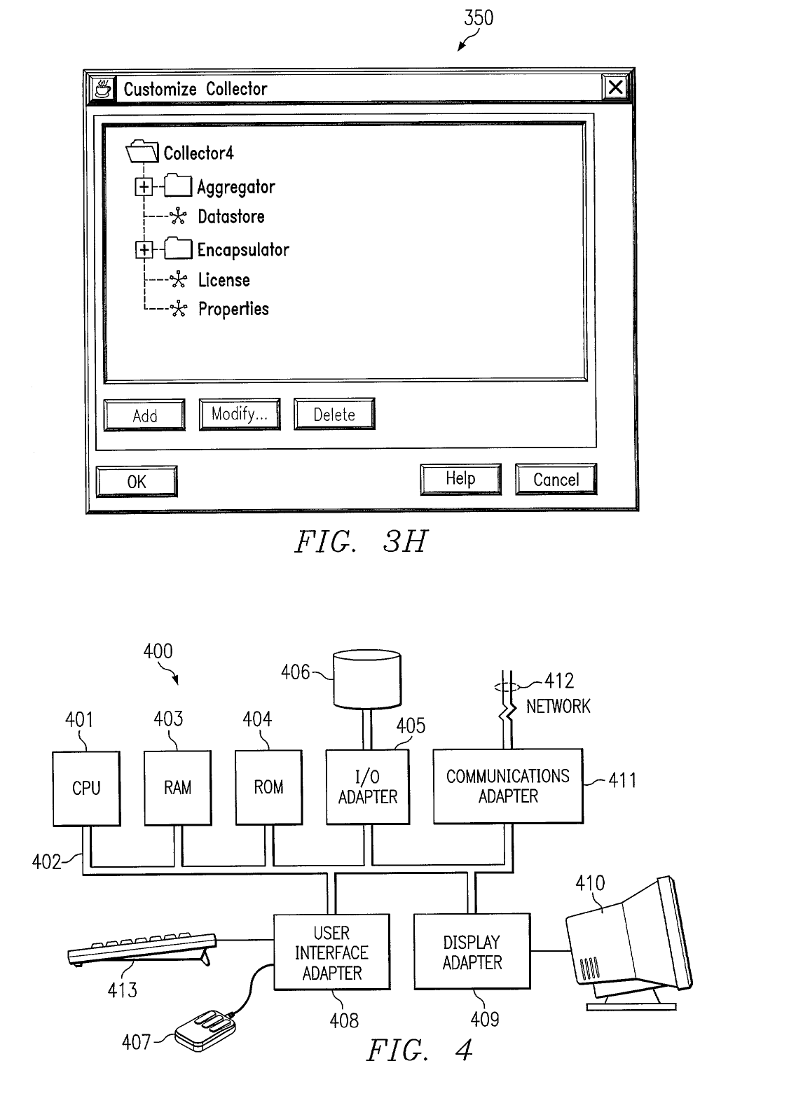

FIG. 4 illustrates computer system 400 adapted to use the present invention. Central processing unit (CPU) 401 is coupled to system bus 402. The CPU 401 may be any general purpose CPU, such as an HP PA-8500 or Intel Pentium processor. However, the present invention is not restricted by the architecture of CPU 401 as long as CPU 401 supports the inventive operations as described herein. Bus 402 is coupled to random access memory (RAM) 403, which may be SRAM, DRAM, SDRAM, or the like. ROM 404 is also coupled to bus 402, which may be PROM, EPROM, EEPROM, or the like. RAM 403 and ROM 404 hold user and system data and programs as is well known in the art.

Bus 402 is also coupled to input/output (I/O) controller card 405, communications adapter card 411, user interface card 408, and display card 409. The I/O card 405 connects to storage devices 406, such as one or more of a hard drive, a CD drive, a floppy disk drive, a tape drive, to the computer system. Communications card 411 is adapted to couple the computer system 400 to a network 412, which may be one or more of a telephone network, a local (LAN) and/or a wide-area (WAN) network, an Ethernet network, and/or the Internet network. User interface card 408 couples user input devices, such as keyboard 413 and pointing device 407, to the computer system 400. The display card 409 is driven by CPU 401 to control the display on display device 410.

What is claimed is:

1. A user interface tool comprising:
a software object creation process providing guidance to a user with respect to creation of a software object by said software object creation process; and
an information communication link to a software object editor, said link providing information with respect to said software object created by said software object creation process to facilitate operation of said software object editor with respect to said software object.

2. The user interface tool of claim 1 wherein said software object creation process comprises a software wizard.

3. The user interface tool of claim 1 wherein said software object comprises a data collector.

4. The user interface tool of claim 1 wherein said software object comprises a plurality of selectable attributes for which said software object creation process facilitates selection of by said user.

5. The user interface tool of claim 4 wherein said selectable attributes are configurable by said software object editor.

6. The user interface tool of claim 5 wherein said selectable attributes must be configured by said software object editor prior to proper operation of said software object.

7. The user interface tool of claim 1 further comprising:
a software object configuration option process providing said user with information with respect to configuration of said software object.

8. The user interface tool of claim 7 wherein said software object configuration option provides selectable activation of said information communication link.

9. The user interface tool of claim 8 wherein said software object configuration option process further provides selectable repeating of said software object creation process.

10. The user interface tool of claim 1 wherein said information communication link is established after substantial completion of said software object creation process.

11. The user interface tool of claim 1 wherein said information communication link is established in proximity to selection of a software object attribute for which said software object editor provides configuration editing.

12. A method for configuring a software object, said method comprising:
providing guidance to a user with respect to selection of attributes of a software object;
providing information to said user with respect to configuring selected ones of said attributes of said software object; and
providing information with respect to said software object to a software object editor to facilitate operation of said software object editor for configuring said selected ones of said attributes of said software object.

13. The method of claim 12 wherein said providing guidance with respect to selection of attributes of said software object guides said user through creating said software object.

14. The method of claim 12 wherein said software object created by said software object creation process comprises a data collector and said attributes of said software object include a data input aspect, a data processing aspect, and a data store aspect.

15. The method of claim 12 wherein said attributes of said software object are configured by said software object editor prior to proper operation of said software object.

16. The method of claim 12 wherein said providing information to said software object editor utilizes selectable activation of an information communication link between a user interface tool providing said guidance to said user and said software object editor.

17. The method of claim 16 further comprising:
activating said selectable activation of said information communication link upon substantial completion of said providing guidance to said user.

18. The method of claim 16 further comprising:
activating said selectable activation of said information communication link upon selection of a software object aspect for which said software object editor provides configuration editing.

19. The method of claim 16 further comprising:
repeating said providing guidance to said user, said providing information to said user, and providing information to said software object editor to thereby provide continuous configuration of a plurality of software objects.

20. A computer program product for use in creating a data collector and providing configuration of said data collector, said computer program product comprising:
a processor readable medium having processor readable code stored thereon, wherein said processor readable code includes;
a data collector creation process providing guidance to a user with respect to creation of a software object;
a data collector configuration option process operable after substantial completion of said data collector creation process, wherein said data collector configuration option process provides information with respect to configuration of said software object created by said data collector creation process, wherein said data collector configuration option process includes a user selectable option to establish a communication link with and launch an external editor process, said communication link providing information with respect to said data collector created by said data collector creation process to facilitate configuration of said data collector using said editor process, and wherein said data collector configuration option process also includes a user selectable option to repeat operation of said data collector creation process and said data collector configuration option process for creating and configuring a plurality of data collectors.
